(19) United States
(12) Patent Application Publication
(10) Pub. No.: US 2009/0313616 A1
(43) Pub. Date: Dec. 17, 2009

(54) Code reuse and locality hinting

(76) Inventors: Cheng Wang, Santa Clara, CA (US); Youfeng Wu, Palo Alto, CA (US)

Correspondence Address: David P. McAbee;c/o Intellevate, LLC, P.O.Box 52050, Minneapolis, MN, 55402, US

(21) Appl. No.: 12/139,647

(22) Filed: Jun. 16, 2008

(51) Int. Cl. G06F 9/45

(52) U.S. Cl. 717/159

(57) ABSTRACT

A method and apparatus for improving parallelism through optimal code replication is herein described. An optimal replication factor for code is determined based on costs associated with a plurality of replication factors. The code is replicated by the optimal replication factor, and then the code is potentially executed in parallel to obtain parallelized efficient execution.

### FIELD

This invention relates to the field of execution of code in computer systems and, in particular, to parallelizing execution of code in computer systems.

### BACKGROUND

Advances in semi-conductor processing and logic design have permitted an increase in the amount of logic that may be present on integrated circuit devices. As a result, computer system configurations have evolved from a single or multiple integrated circuits in a system to multiple cores and multiple logical processors present on individual integrated circuits. A processor or integrated circuit typically comprises a single processor die, where the processor die may include any number of processing elements, such as cores, hardware threads, or logical processors.

The ever increasing number of processing elements on integrated circuits enables more software threads to be executed. However, many single-threaded applications still exist, which utilize a single processing element, while wasting the processing power of other available processing elements. Alternatively, programmers may create multi-threaded code to be executed in parallel. However, the multi-threaded code may not be optimized for a number of available processing elements.

### BRIEF DESCRIPTION OF THE DRAWINGS

The present invention is illustrated by way of example and not intended to be limited by the figures of the accompanying drawings.

FIG. 1 illustrates an embodiment of a processor multiple processing elements capable of executing multiple software threads.

FIG. 2 illustrates an embodiment of a flow diagram for a method of optimally parallelizing code.

FIG. 3 illustrates an embodiment of a flow diagram for a method of replicating code.

FIG. 4 illustrates an embodiment of an illustrative example for replicating a basic block of code by a replication factor of two.

FIG. 5 illustrates an embodiment of a dependence graph annotated with dependence distances for the replicated code of FIG. 4.

### DETAILED DESCRIPTION

In the following description, numerous specific details are set forth such as examples of specific algorithms for identifying dependence chains, expressing paths between instructions, determining cost for different levels of cost replication in order to provide a thorough understanding of the present invention. It will be apparent, however, to one skilled in the art that these specific details need not be employed to practice the present invention. In other instances, well known components or methods, such as multi-processing parallel execution, identifying strongly-connected code blocks, specific compiler or other instruction insertion and replications techniques, and other specific operation details, have not been described in detail in order to avoid unnecessarily obscuring the present invention.

The method and apparatus described herein are for optimal code replication for improving parallelism. Specifically, code replication is primarily discussed in reference to single-threaded applications including strongly connected code regions. However, the methods and apparatus for optimally replicating code are not so limited, as they may be implemented in associated with any code, such as dependent chains within a multi-threaded program or non-strongly connected code regions.

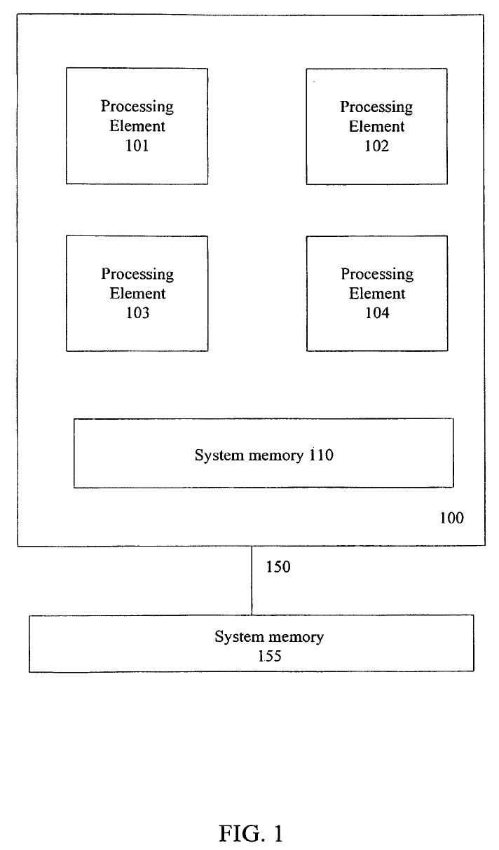

Referring to FIG. 1, an embodiment of a processor capable of optimal code replication is illustrated. Processor 100 includes any processor, such as a micro-processor, an embedded processor, a digital signal processor (DSP), a network processor, or other device to execute code. As illustrated, processor 100 includes four processing elements 101-104; although, any number of processing elements may be included in processor 100.

A processing element refers to a thread unit, a process unit, a context, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. As an example, a physical processor typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. Therefore, as can be seen, multiple software threads, such as multiple replications of a single-threaded application, in one embodiment, are capable of being executed in parallel on multiple processing elements, which may include a combination of any of the aforementioned processing elements, such as cores or hardware threads.

Also illustrated in processor 100 are resources 110, which typically include registers, units, logic, firmware, memory, and other resources to execute code. As stated above, some of resources 110 may be partially or fully dedicated to processing elements, while others are shared among processing elements. For example, smaller resources, such as instruction pointers and renaming logic may be replicated for threads. Some resources, such as re-order buffers in a reorder/retirement unit, instruction lookaside translation buffer (ILTB), load/store buffers, and queues may be shared through partitioning. Other resources, such as general purpose internal registers, page-table base registers, data-cache, a data-TLB, execution unit(s), and an out-of-order unit are potentially fully shared among threads. In contrast, cores may have dedicated execution resources, while sharing at least a portion of a higher level cache, such as a second level cache (L2).

Processor 100 is coupled to system memory 155 through interconnect 150. Often, processors, such as a microprocessor, are coupled in a computer system in different configurations. For example, in one embodiment, processor 100 is coupled to a chipset, which includes an interconnect hub and a memory controller hub disposed between processor 100 and system memory 155. As a result, for the discussion in regards to system memory 155, processor 100 may be coupled to system memory 155 in any manner.

In one embodiment, optimal code replication includes determining an optimal number of times to replicate a section or region of code. As an example, a cost associated with different replication factors, i.e. different numbers of replications of a code section, are determined. These costs may be measured in any manner, such as execution cycles, execution times, instruction counts, or any other known method of measuring cost of executing code. In one embodiment, an instruction count of the longest dependence chain within the section of code is a maximum cost for each replication factor.

The costs for each considered replication factor are determined, and the lowest cost replication factor is selected as an optimal replication factor. In one embodiment, a number related to an amount of processing elements available to execute replicated code is utilized as a maximum replication factor. For example, in FIG. 1 there are four processing elements available to execute code. As a result, replication factors of 4-8 are considered for parallelization, as no more than the four instances of the code is capable of being executed on processor 100. Once the code is replicated by the optimal number of factors, then upon execution, independent dependence chains from the replicated code are executed in parallel on separate processing elements of processor 100 to obtain improved parallelism.

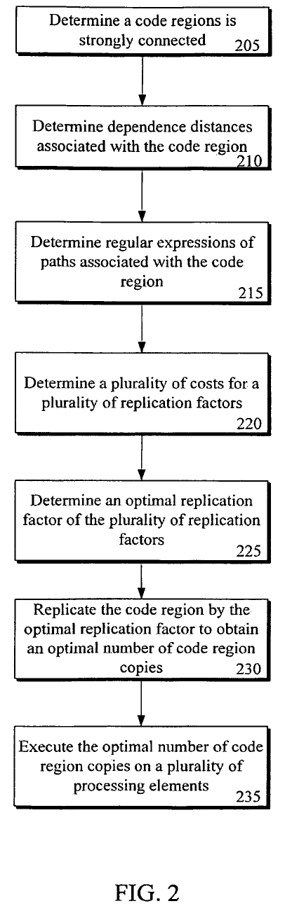

Turning to FIG. 2, an embodiment of a flow chart for a method of optimal code replication for improving parallelism is illustrated. Although blocks 205-235 are illustrated in a substantially serial fashion, performance of the blocks may be done in any order, as well as performed partially of wholly in parallel. Additionally, in other embodiments, more blocks, not illustrated, such as determining instruction counts may be performed, while other blocks, such as block 205 and/or block 235 are not performed.

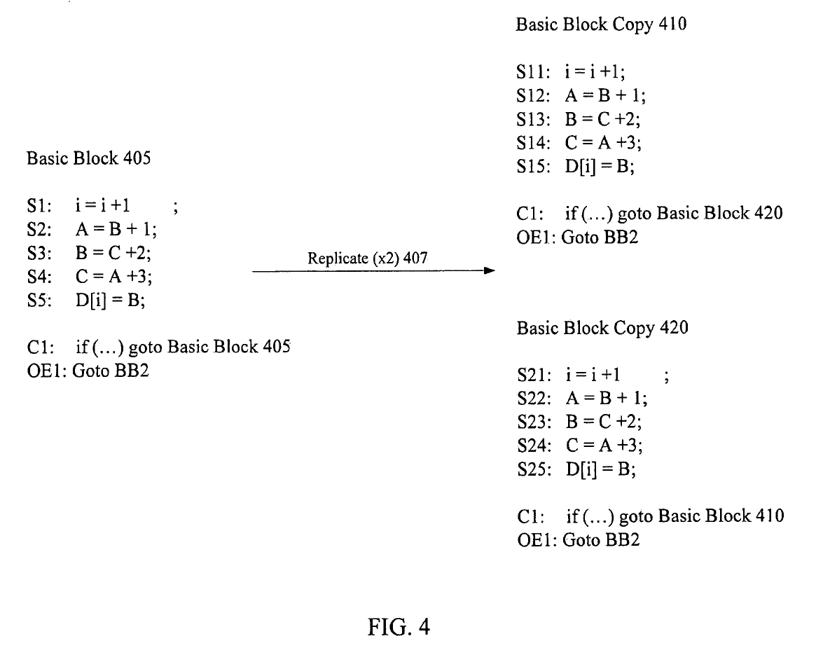

In block 205 a code region is determined to be strongly connected. In one embodiment, a code region includes any section or block of code, which may vary in size and structure. As an illustrative example, a code region or section includes one or more basic blocks of code. Here, a basic block of code includes a list of statements, which may also be referred to as nodes or instructions. Note, the list of statements may be cyclic, i.e. loop on itself, as illustrated in the exemplary code of FIG. 4 where basic block 405 includes a conditional statement 1 (C1) that loops back to basic block 405.

In one embodiment, determining a code section/region is strongly connected includes determining that each node within a code section is capable of reaching other nodes in the code section. However, any known method for identifying a strongly connected codes section/region may be utilized.

In one embodiment, determining a code section is a strongly connected code section is a condition to attempting replication of a code section. Here, determining that a code section is a strongly connected code section before attempting replication potentially aids in allowing replication of different dynamic instances of a same instruction into different static instructions, as well as avoiding developing dead sections of code during replication.

Also note that as the number of basic blocks or nodes within a code section that are capable of reaching each other changes, so the size of a strongly connected code section may also change. As a result, a single application potentially has different size code sections eligible for replication. Yet, based on a design implementation, code sections within the same code/applicant may be the same size or different sizes. Furthermore, code replication as described herein is not limited to replication of strongly connected code, as code replication may be implemented with other sections, blocks, and/or regions of code that are not strongly connected.

Within a code section, a single or multiple edges may be selected/determined to be inter-replication edges, while other inter-replication edges may be treated as intra-replication edges. Note a strongly connected control flow graph may include strongly connected sub-graphs.

In one embodiment, a control flow graph is utilized to describe/represent a strongly connected section/region of code. For example, if a code section is represented in a control flow graph (V, E), where V is the set of basic blocks in the code section and E is the set of control flow edges, such that the edge set E is broken into two edge sets: an intra-replication edge set E1 and an inter-replication edge set E2, then the code section is determined to be strongly connected in response to there being a path from v2 to v1 in E1 for each edge <v1,v2>∈E2. In other words, as described by the control flow graph, a code region is strongly-connected, when each node within a code section can reach the other nodes of the code section, i.e. there is an inter-replication edge (path from v2 to v1 in E1) for each intra-replication edge in E2.

In block 210 dependence distances associated with the code region are determined. When a code region is replicated by a factor N, then after replication, N copies or N instances of the code region exist. Consequently, some dynamic instructions from one instance of the code region may depend on another dynamic instruction of another instance of the code section. For example, quickly referring to FIG. 4, an oversimplified illustrative example of replicating code by a factor of two is illustrated. Basic block 405 is replicated into two copies, i.e. basic block instance 410 and basic block instance 420. Note that the statements/instructions are replicated, such that S1 is a first instance of S1 and S21 is a second instance of S1. Here, statement 13 (S13), which may also be referred to as an instruction, in instance 410 potentially depends on the output of statement 24 (S24) of instance 420.

As a result, in one embodiment, dependence distances are determined with respect to inter-replication edges. As an illustrative example, if a first instruction in one instance of a code region depends on a second instruction in another instance of the code region, then a dependence distance includes how many inter-replication edges are traversed by data output from the second instruction to reach the instance of code including the first instruction. As an example, for data in registers, the dependence distances may be determined by whether or not the data flow crosses the inter-replication edges. In one embodiment, memory profiling with an instance counter incremented on the execution of inter-replication edges of the code region and recorded on each memory load and store provides dependence distances for memory data.

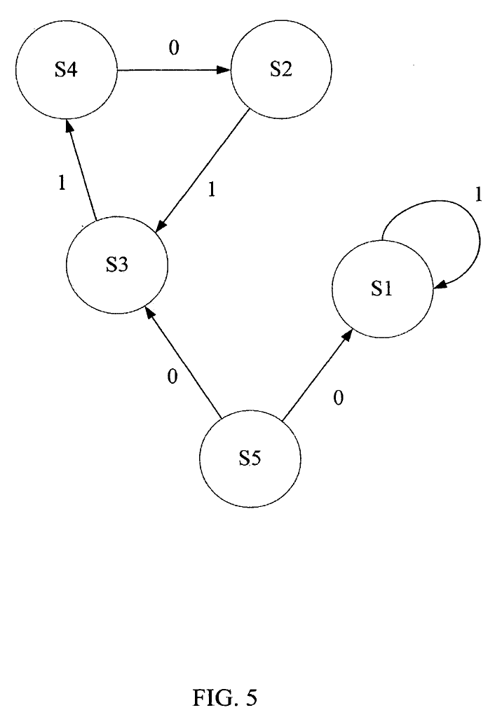

As a potential aid in determining dependence distances among instructions in a code region, in one embodiment, an annotated dependence graph is formed. Continuing the example of FIG. 4, an illustrative embodiment of a dependence graph for the code in FIG. 4 is illustrated in FIG. 5. Although the dependence graph of FIG. 5 is illustrated in a pictorial manner, any method of representing dependencies may be utilized, such as a list or other textual representation of a dependence graph. Also note that the illustrated dependence graph is representative of each instance of the code region, i.e. block 405, block 410 and block 420.

Here, the dependence graph essentially illustrates which statement (S1-S5) utilizes data/values from which instance of code. For example, statement 14 (S14) of basic block copy 410 (first instance) produces the data/value for statement 23 (S23) of basic block instance 420 (second instance). As a result, a dependence distance of 1 is illustrated for the path of statements 3 (S3) to statement 4 (S4).

So transitively, if there is a path from an instruction 1, such as statement 1 (S1), to a instruction 2, such as statement 2 (S2), with length p, i.e. a sum of all dependence distances of the edges along the path from S1 to S2, then an instance (i) of instruction S1 in a replicated copy transitively depends on the instance (i-p) of S2. Note, in one embodiment, after code replication by factor n, the instance of instruction 1 transitively depends on instruction 2(instance−p mod n).

As an example from FIG. 5, there is a path from S5 to S2 with length one, i.e. S5→4S3(0)+S3→S4(1)+S4→S2(0). So, here instance i of instruction S5 transitively depends on the instance i-1 of instruction S2. Therefore, if the basic block 405 is replicated by a factor of two into basic block 410 and 415, then S15 will transitively depend on S22, and S25 will transitively depend on S12. Alternatively, if basic block 405 is replicated by a factor of three, then the first instance of S5 will transitively depend on the third instance of S2, the second instance of S5 will transitively depend on the first instance of S2, and the third instance of S5 will transitively depend on the second instance of S2.

In one embodiment, the paths associated with a code section are determined. Any method of expressing paths in code may be utilized to summarize paths within a code section. For example, path algorithms, such as those disclosed in: “Fast Algorithms for Solving Path Problems,” by Tarjan, R. E. J. ACM 28, 3 (July 1981), 594-614, may be utilized to express all paths from one statement/instruction to another. These algorithms may be repeatedly applied to a dependence graph using concatenation for successive edges, alternation for joins, and Kleene stars for cycles, to get a length of all paths from a first instruction to a second instruction. FIG. A below illustrates an embodiment of regular expressions for paths.

| | |
|---|---|
| R → d | (dependence distance d) |
| R → R · R | (concatenation) |
| R → R\|R | (alternation) |
| R → R* | (Kleene star) |

FIG. A: An embodiment of regular expressions for paths

To continue the example from above in reference to the dependence graph of FIG. 5, FIG. B below illustrates an example of a length for all paths from statement 5 (S5) of FIG. 4 to other statements (S1-S5) as regular expressions. Note that R(S5,S2)=1·2* indicates that on a first trip the length is 1 and subsequent trips the length is 2, as can be seen by traversing the edges of the dependence graph of FIG. 5.

R(S5, S1)=1*

R(S5, S2)=1·2*

R(S5, S3)=2*

R(S5, S4)=1·2*

R(S5, S5)=0

FIG. B: An embodiment of regular expressions for paths from S5

In one embodiment, a cost for each of a plurality of replication factors is determined. Theoretically, the number of replication factors may be infinitely large. However, as a practical consideration, in one embodiment, a maximum replication factor is potentially limited by a multiple of the number of processing elements available to execute replicated instances of a code region. Here, the number of processing elements available may be dynamically determined, statically predetermined by implementation, statically predetermined by a number of processing elements present in a system, or otherwise determined by any known method of evaluating a number of processing elements. In another embodiment, a practical maximum replication factor is intelligently selected to include likely optimal replication factors while avoiding evaluation of too many replication factors.

Given a set of lengths for paths from a first instruction one to a second instruction two expressed as regular expression R and a replication factor n, in one embodiment, it is determined which instance/copy of instruction two that instruction one is depended upon for a value. For example, P(R, n) is calculated such that for each member p∈P(R, n), 0<=p<n, instruction 1 (instance) depends on instruction 2((instance−p) mod n), 0<=instance<n, with the following recursive expressions: P(d, n)={d mod n}; P(R1·R2, n)={(p1+p2) mod n|p1∈P(R1, n), p2∈P(R2, n)}; P(R1|R2, n)=P(R1, n)∪P(R2, n); and P(R*, n)={c*t|c=GCD ({p|p∈P(R, n)}∪{n}), 0<=t<n/c Note that the last recursive statement comes from equations: {p|p=p1*t+p2*t}={p|p=GCD({P1,P2})*t} and {p|p=(p1*t) mod p2}={c*t|c=GCD({P1,P2}), 0<=t<p2/c}, where GCD(L) is the greatest common divider of all number in a set L.

To illustrate, FIG. C depicts an embodiment of the expressions of P(R,n) where n is equal to the replication factor of two for the code region of FIG. 4.

P(R(S5, S1), 2)=P(1*, 2)={0, 1}

P(R(S5, S2), 2)=P(1·2*, 2)={1}

P(R(S5, S3), 2)=P(2*, 2)={0}

P(R(S5, S4), 2)=P(1·2*, 2)={1}

P(R(S5, S5), 2)=P(0, 2)={0}

FIG. C: An embodiment of P(R,n) where n=2

Note that each element p in set P(R(instruction 1, instruction 2), n) provides an unique (instance-p mod n) for the instruction 1 that an instance of instruction 2 depends on. Then the set size (the number of unique element in the set, represented as ∥P(R(instruction 1, instruction 2), n)∥ of P(R(instruction 1, instruction 2), n) gives the number of replications of instruction 2 that each instance of instruction 1 depends on. Suppose the total execution count of instruction 2 in this region is W(instruction 2). After code replication by factor n, the execution count of each replicated instance of instruction 2, 0<=instance number<n, is W(instruction 2)/n. Then after code replication by factor n, the number of dynamic instances of instruction 2 that must run on a single core that an instance of instruction 1 runs on is: ∥P(R(instruction 1, instruction 2), n)∥*W(instruction 2)/n.

As an example, for basic block 405 of FIG. 4, an instruction execution count W for each instruction is: W(S1)=N; W(S2)=N; W(S3)=N; W(S4)=N; and W(S5)=N. However, if we replicate the code by a factor of 2, such as into blocks 410 and 420, then the instruction count is:

∥P(R(S5, S1),2)∥*W(S1)/2=∥{1}∥*N/2=N

∥P(R(S5, S2), 2)∥*W(S2)/2=∥{1}∥*N/2=N/2

∥P(R(S5, S3), 2)∥*W(S3)/2=∥{0}∥*N/2=N/2

∥P(R(S5, S4), 2)∥*W(S4)/2=∥{1}∥*N/2=N/2

∥P(R(S5, S5), 2)∥*W(S5)/2=∥{0}∥*N/2=N/2

FIG. D: An embodiment of an instruction count for a replication factor of two

As a result, the instruction count on each core that an instance of S5 runs on is: N+N/2+N/2+N/2+N/2=3*N. In comparison if a replication factor of thee is used, then the instruction count is:

∥P(R(S5, S1), 3)∥*W(S1)/3=∥P(1*,3)∥*N/3=∥{0, 1, 2}∥*N/3=N

∥P(R(S5, S2), 3)∥*W(S2)/3=∥P(1·2*, 3)∥*N/3=∥{0, 1, 2}∥*N/3=N

∥P(R(S5, S3), 3)∥*W(S3)/3=∥P(2*, 3)∥*N/3=∥{0, 1, 2}∥*N/3=N

∥P(R(S5, S4), 3)∥*W(S4)/3=∥P(1·2*, 3)∥*N/3=∥{0, 1, 2}∥*N/3=N

∥P(R(S5, S5), 3)∥*W(S5)/3=∥P(0, 3)∥*N/3=∥{0}∥*N/3=N/3

FIG. E: An embodiment of an instruction count for a replication factor of three

Here, the instruction count on each core that an instance of S5 runs on is: N+N+N+N+N/3=13*N/3, which is worse than the code replication factor of two. This provides an illustrative example of computing costs for different replication factors, as well as the illustrative point that more replication is not always better. In one embodiment, extrapolating the above example for a starting node, such as S1, for each replication factor (n), a cost is equal to: cost(S1,n)=sum(∥P(R(S1, S2), n)∥* W(S2)/n), for all S2). Another statement of cost for a replication factor includes: cost(n) =max(cost(S1,n), for all S1).

Therefore, in one embodiment, an optimal replication factor is determined in block 225. As an example, an optimal replication factor is selected based on a cost associated with each considered replication factor. As stated previously, cost may include any cost of executing code/instructions, such as a length for execution of a section of code or a length of a longest dependence chain of a code region. Here, code is to be parallelized as much as possible to obtain a number of parallel code sections, each of which include as short of an execution length as possible. As can be seen from the example above, the code section from FIG. 4 is optimally replicated twice. Over replication by a factor of three actually results in a larger instruction count. Consequently, in one embodiment, the optimal replication factor includes a lowest cost of a plurality of evaluated replication factors.

In block 230, the code region is replicated by the optimal replication factor to obtain an optimal number of code region copies or instances. For example, basic block 405 is replicated by an optimal factor of two to obtain two instances of code: basic block copy 410 and basic block copy 420. Note after replication two dependence chains now exist between the two instances of code 410 and 420, which can be seen both from the dependence graph and the expressions relating dependence on each other. Here, the first dependence chain includes S11, S21, S22, S13, S24, and S15, while the second dependence chain includes S1, S21, S12, S23, S14, and S25. Note that both replicated instances of S1, i.e. S11 and S21, are include in both dependence chains.

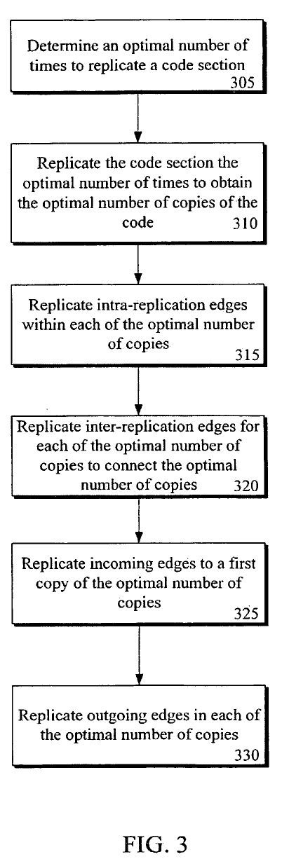

Turning to FIG. 3, an embodiment of a flowchart for a method of replicating a code section is illustrated. In block 305, and optimal number of times to replicate a code section is determined, as discussed above. In block 310, the code section is replicated an optimal number of times to obtain an optimal number of copies of the code section. Intra-replication edges within each instance are replicated/inserted in block 315.

Additionally, inter-replication edges are replicated/inserted in each of the copies to connect the copies of the code region. As stated above, in one embodiment, replicating the inter-replication edges makes for strongly connected replicated code and potentially avoids developing dead code. In block 325 incoming edges, i.e. edges coming into the code section, are directed to a first instance/copy of the code section. In block 330, outgoing edges from the code section are replicated in each of the optimal number of copies. Note again that blocks in FIG. 3 are illustrated in a substantially serial manner; however, each block may be performed in a different order, as well as at least partially in parallel. For example, block 320 may be performed all at once, i.e. inter-replication edges may be replicated into all code sections after all the copies are created, or performed as each copy of code is replicated/created in block 310.

Returning to FIG. 2, after replication in block 230, in block 235 the optimal number of code region copies are executed on a plurality of processing elements. In one embodiment, execution of the optimal number of copies of code includes executing dependent chains of the optimal number of copies of code on a plurality of processing elements. For example, as discussed above in reference to the code of FIG. 4, after replication two dependence chains are obtained, i.e. first dependence chain includes S11, S21, S22, S13, S24, and S15, while the second dependence chain includes S11, S21, S12, S23, S14, and S25. In reference to FIG. 1, the first dependence chain is executed on one processing element, such as processing element 101, in parallel with the second dependence chain being executed on a second processing element, such as processing element 102.

As a result, in this example, the original instruction count of basic block 405 was 5*N. After replication by a factor of two, each processing element now executes 3*N instructions in parallel, which has a potential parallelism of 5/3=1.7. In contrast, note from above that replication by a factor of 3 would lead to an instruction count of 13*N/3, which results in less parallelism (1.15) than a replication by a factor of two. Consequently, here the replication by a factor of two is considered to be the optimal replication factor in comparison to a factor of three due to the potential greater parallelism, i.e. the lower instruction count.

Therefore, as can be seen from above, code sections/regions are replicated to improve parallelism between instructions. However, pure replication in itself does not always provide more efficient parallelism. As a result, an optimal replication factor for sections of code is determined based on costs associated with replication factors. Consequently, an optimal replication of code sections for providing efficient parallelism is obtained to efficiently improve parallelism of instructions.

A module as used herein refers to any hardware, software, firmware, or a combination thereof. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices. However, in another embodiment, logic also includes software or code integrated with hardware, such as firmware or micro-code.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical storage device, optical storage devices, acoustical storage devices or other form of propagated signal (e.g., carrier waves, infrared signals, digital signals) storage device; etc. For example, a machine may access a storage device through receiving a propagated signal, such as a carrier wave, from a medium capable of holding the information to be transmitted on the propagated signal.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An article of manufacture including program code which, when executed by a machine, causes the machine to perform the operations of:
determining an optimal replication factor for a code region from a plurality of replication factors based on a cost associated with each of the plurality of replication factors; and
replicating the code region by the optimal factor.

2. The article of manufacture of claim 1, wherein the program code which, when executed by a machine, causes the machine to further perform the operations of:
determining the plurality of replication factors are equivalent to a number of processing elements available in the machine.

3. The article of manufacture of claim 1, wherein determining an optimal replication factor for a code region from a plurality of replication factors based on a cost associated with each of the plurality of replication factors comprises:
identifying a plurality of inter-replication edges and a plurality of intra-replication edges within the code region; and
determining dependence distances with respect to data flowing across the plurality of inter-replication edges.

4. The article of manufacture of claim 3, wherein determining an optimal replication factor for a code region from a plurality of replication factors based on a cost associated with each of the number of the plurality of replication factors further comprises:
determining instruction counts for the code region;
determining regular expressions for paths within the code region; and
determining the cost associated with each of the plurality of replication factors based on the regular expressions and instruction counts.

5. The article of manufacture of claim 4, wherein determining an optimal replication factor for a code region from a plurality of replication factors based on a cost associated with each of the plurality of replication factors further comprises:
determining the optimal replication factor for the code region based on a lowest cost of the cost associated with each of the plurality of replication factors.

6. The article of manufacture of claim 1, wherein the cost associated with each of the plurality of replication factors is based on an instruction count associated with a longest dependence chain of the code region for each of the plurality of replication factors.

7. The article of manufacture of claim 1, wherein replicating the code region by the optimal factor comprises:
replicating the code region the optimal factor of times;
replicating intra-replication edges within the code region the optimal factor of times;
replicating inter-replication edges within the code region the optimal factor of times;
directing incoming edges to a first replication of the code region; and
directing outgoing edges from each of the replications of the code region.

8. The article of manufacture of claim 7, wherein replicating the code region the optimal factor of times includes replicating each basic block of the code region the optimal factor of times.

9. An article of manufacture including program code which, when executed by a machine, causes the machine to perform the operations of:
determining an optimal number of times to replicate a code section;
replicating the code section into the optimal number of copies of the code section; and
inserting an inter-replication edge in each of the optimal number of copies of the code section to interconnect the optimal number of copies of the code section.

10. The article of manufacture of claim 9, wherein the program code which, when executed by a machine, causes the machine to further perform the operations of: determining the code section is a strongly connected control flow code section as a condition to determining the optimal number of times, replicating the code section, and inserting the inter-replication edge.

11. The article of manufacture of claim 9, wherein the program code which, when executed by a machine, causes the machine to further perform the operations of: executing each of the optimal number of copies of the code section in parallel on a plurality of processing elements.

12. The article of manufacture of claim 9, wherein the program code which, when executed by a machine, causes the machine to further perform the operations of:
inserting an incoming edge of the code section into a first copy of the code section of the optimal number of copies of the code section; and
inserting an outgoing edge of the code section into each of the optimal number of copies of the code section.

13. The article of manufacture of claim 12, wherein determining an optimal number of times to replicate a code section comprises:
determining dependence distances associated with the code section;
determining instruction counts associated with the code section;
determining regular expressions of paths associated with the code section;
determining a cost based on the regular expressions and the instruction counts for a plurality of replication factors of the code section; and
determining the optimal number of times of the plurality of replication factors to replicate the code section.

14. A method comprising:
determining a plurality of dependence distances associated with a block of code;
determining a plurality of costs associated with a plurality of replication factors based on the plurality of dependence distances;
determining an optimal replication factor of the plurality of replication factors based on the plurality of costs associated with the plurality of replication factors; and
replicating the block of code by the optimal replication factor to obtain an optimal replication factor of copies.

15. The method of claim 14, further comprising:
determining the block of code is associated with a strongly connected control flow graph; and
determining the plurality of replication factors is a number of replication factors associated with a number of processing elements available in a computer system.

16. The method of claim 14, wherein each of the plurality of costs include a longest dependent chain cost associated with each of the plurality of replication factors for the block of code.

17. The method of claim 14, further comprising executing each of the replication factor of copies on a processing element at least partially in parallel with each other.

18. The method of claim 14, wherein determining a plurality of costs associated with a plurality of replication factors based on the plurality of dependence distances comprises:
determining a plurality of regular expressions to express a plurality of paths associated with the block of code based on the plurality of dependence distances;
determining a plurality of instruction counts associated with the block of code based on the plurality of regular expressions; and
determining the plurality of costs associated with the plurality of replication factors based on the plurality of instruction counts.

19. The method of claim 18, wherein determining an optimal replication factor of the plurality of replication factors based on the plurality of costs associated with the plurality of replication factors comprises: determining the optimal replication factor of the plurality of replication factors based on a lowest cost of the plurality of costs.
